(19) United States
(12) Patent Application Publication
(10) Pub. No.: US 2007/0184211 A1
(43) Pub. Date: Aug. 9, 2007

(54) Sealant and liquid crystal display including same

(75) Inventors: Yeon-Cu Kim, Asan-si (KR); Jong-Oh Kim, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/704,486

(22) Filed: Feb. 9, 2007

(30) Foreign Application Priority Data
Feb. 9, 2006 (KR) 10-2006-0012463

(51) Int. Cl. G02F 1/1339

(52) U.S. Cl. 428/1.5; 349/190

(57) ABSTRACT

A liquid crystal display and a method of manufacturing the same include a first display panel and a second display panel that face each other, a sealant that contains polymer resin formed by curing methacrylic acid or a s derivative thereof to sealingly assemble the first display panel and the second display panel, and a liquid crystal provided in the region between the first display panel and the second display panel.

### CROSS-REFERENCE TO RELATED APPLICATION

This application claims priority to and the benefit of Korean Patent Application No. 10-2006-0012463 filed in the Korean Intellectual Property Office on Feb. 9, 2006, the entire contents of which are incorporated herein by reference.

### BACKGROUND OF THE INVENTION

1. Field of the Invention

The present invention relates to a sealant for a display device and a liquid crystal display including the same.

2. Description of the Related Art

Recently, liquid crystal displays (LCD) have been widely used as flat panel displays. The liquid crystal display includes two display panels in which field generating electrodes are formed, and a liquid crystal layer interposed between the two display panels. In the liquid crystal display, a voltage is applied to the field generating electrodes so as to generate an electric field in the liquid crystal layer. The alignment of liquid crystal molecules in the liquid crystal layer is determined by the electric field and controls the transmittance of light passing through the liquid crystal layer.

A liquid crystal display in which field generating electrodes are respectively provided on two display panels having a plurality of pixel electrodes arranged on one of the panels in a matrix shape and in which a common electrode covers an entire surface of another display panel is frequently used.

In such a liquid crystal display, an additional voltage is applied to the pixel electrodes in order to display images. To this end, thin film transistors (TFTs) that are three-terminal elements are correspondingly connected to the pixel electrodes in order to switch the voltage applied to the pixel electrodes. Further, gate lines that transmit signals for controlling the thin film transistors and data lines that transmit the voltage to be applied to the pixel electrodes are formed.

The thin film transistors function as switching elements that transmit data signals through the data lines to the pixel electrodes or block the data signals depending on scanning signals applied to the gate lines.

A sealant including a resin cured by ultraviolet rays (UV) or heat is used between the display panels to bond the panels to each other and to seal-in the liquid crystal between the panels.

However, when unstable radicals occur during curing of the sealant, a large amount of uncured resin may remain due to unexpected termination reactions or side reactions. The uncured resin may be diffused into the liquid crystal layer during the driving of the liquid crystal display due to an increase in temperature caused by the backlight unit and may be observed as a stain or a residual image which has an undesirable effect on display characteristics.

### SUMMARY OF THE INVENTION

According to one aspect of the present invention a sealant for a liquid crystal display improves display characteristics by reducing the possibility of stain or a residual image caused by curing of the sealant.

An exemplary embodiment of the present invention provides a sealant containing methacrylic acid or a derivative thereof, a photoinitiator, and a filler.

The derivative of methacrylic acid may be expressed by Formula I.

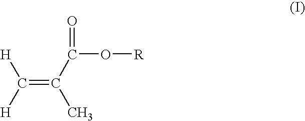

In Formula I, R may be any one selected from the group consisting of an amide group, an ester group, an ether group, a sulfide group, a sulfoxide group, a hydroxy group, an imide group, an aza group, an amine group, an azo group, an aldehyde group, a carboxylic group, anhydrides, halides, and ureas.

The sealant may further contain at least one of acrylic acid or a derivative thereof, and an epoxy compound.

Methacrylic acid or the derivative thereof, acrylic acid or the derivative thereof, and the epoxy compound may have a content of about 45 to 75% by weight with respect to the total content of the sealant.

Methacrylic acid or the derivative thereof may have a content of about 0.1 to 98% by weight with respect to the total content of methacrylic acid or the derivative thereof, acrylic acid or the derivative thereof, and the epoxy compound.

Another embodiment of the present invention provides a display device including a first display panel and a second display panel that face each other, a sealant that contains polymer resin formed by curing methacrylic acid or a derivative thereof to assemble the first display panel and the second display panel, and a liquid crystal that is provided in a region defined by the sealant between the first display panel and the second display panel.

The derivative of methacrylic acid may be expressed by Formula I.

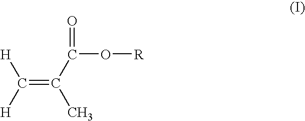

In Formula I, R may be any one selected from the group consisting of an amide group, an ester group, an ether group, a sulfide group, a sulfoxide group, a hydroxy group, an imide group, an aza group, an amine group, an azo group, an aldehyde group, a carboxylic group, anhydrides, halides, and ureas.

The sealant may further include a polymer resin formed by curing at least one of acrylic acid or a derivative thereof and an epoxy compound.

The sealant may further include at least one of a photoinitiator, a filler, and an additive.

At least one of the first display panel and the second display panel may further include field generating electrodes.

The first display panel or the second display panel may include gate lines, data lines that cross the gate lines, and thin film transistors that are connected to the gate lines, the data lines, and the field generating electrodes.

Another embodiment of the present invention provides a method of manufacturing a liquid crystal display including forming a first display panel and a second display panel having a plurality of thin film patterns, forming a sealant that contains methacrylic acid or a derivative thereof on any one of the first display panel and the second display panel, providing liquid crystal on any one of the first display panel and the second display panel, assembling the first display panel and the second display panel to each other, and curing the sealant.

The curing of the sealant may be performed using at least one of light irradiation and heating.

The forming of the first display panel may include forming gate lines on a first substrate, forming a semiconductor layer on the gate lines, forming data lines and drain electrodes that cross the gate lines so as to be insulated from the gate lines, and forming pixel electrodes correspondingly connected to the drain electrodes.

### BRIEF DESCRIPTION OF THE DRAWINGS

FIG. 1 is a layout view of a liquid crystal display according to an exemplary embodiment of the present invention;

FIG. 2 is a cross-sectional view of the liquid crystal display of FIG. 1 taken along the line II-II;

FIGS. 3, 5, 7, 9, and 11 are layout views sequentially showing a method of manufacturing a thin film transistor display panel according to an exemplary embodiment of the present invention;

FIG. 4 is a cross-sectional view of the thin film transistor display panel of FIG. 3 taken along the line IV-IV;

FIG. 6 is a cross-sectional view of the thin film transistor display panel of FIG. 5 taken along the line VI-VI;

FIG. 8 is a cross-sectional view of the thin film transistor display panel of FIG. 7 taken along the line VIII-VIII;

FIG. 10 is a cross-sectional view of the thin film transistor display panel of FIG. 9 taken along the line X-X;

FIG. 12 is a cross-sectional view of the thin film transistor display panel of FIG. 11 taken along the line XII-XII;

FIG. 13 is a plan view showing a case where a sealant and liquid crystal are formed, subsequent to FIGS. 11 and 12;

FIG. 14 is a cross-sectional view showing a structure when a thin film transistor display panel and a common electrode display panel are bonded to each other; and

FIGS. 15A and 15B are photographs showing the generation of stains on the liquid crystal display when a sealant containing a derivative of methacrylic acid and a sealant including a derivative of acrylic acid are used, respectively.

### DETAILED DESCRIPTION OF THE EMBODIMENTS

Hereinafter, a sealant for a display device according to an exemplary embodiment of the present invention will be described in detail. The sealant for a display device according to the exemplary embodiment of the present invention comprises a monomer containing methacrylic acid and a derivative thereof, a photoinitiator, and a filler.

Methacrylic acid and the derivative thereof are expressed by Formula I.

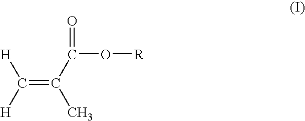

In Formula I, in the case of methacrylic acid, R may be hydrogen (H). Further, in the case of the derivative of methacrylic acid, R may be any one selected from the group consisting of an amide group, an ester group, an ether group, a sulfide group, a sulfoxide group, a hydroxy group, an imide group, an aza group, an amine group, an azo group, an aldehyde group, a carboxylic group, anhydrides, halides, and ureas.

Methacrylic acid and the derivative thereof may have a content of about 0.1 to 98% by weight with respect to the total content of the monomer.

Methacrylic acid and the derivative thereof may create more stable radicals compared with acrylic acid and a derivative thereof.

For comparison of radical stability of methacrylic acid and acrylic acid, a description will be given with reference to Reaction Equations (A-a) to (B-c).

The following Reaction Equation (A-a) schematically shows a reaction where a monomer of an acrylic acid derivative having the above-mentioned functional group (R) form radicals using an initiator (I).

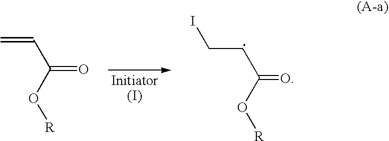

The radicals react with other monomers to be polymerized according to the following Reaction Equation (A-b) or (A-c).

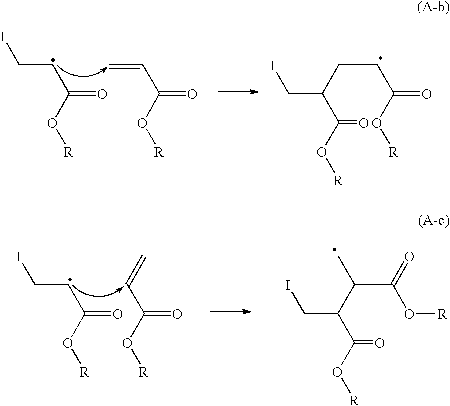

The Reaction Equations (A-b) and (A-c) are different according to with which carbon atom the radicals generated according to the Reaction Equation (A-a) react among carbon atoms forming carbon-carbon double bonds (C═C). The Reaction Equation (A-b) shows a normal reaction for forming a desired polymer, and the Reaction Equation (A-c) shows a side reaction.

Since the radicals generated according to the Reaction Equation (A-c) are very unstable, the reaction may be finished early, and thus the radicals may form resin having a low molecular weight or remain as uncured resin.

In contrast, methacrylic acid and the derivative thereof may reduce the side reaction.

The following Reaction Equation (B-a) schematically shows a reaction where the derivative of methacrylic acid having the above-mentioned functional group (R) form radicals using the initiator (1).

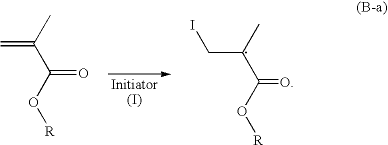

The resultant radicals react with other monomers to be polymerized, like the following Reaction Equation (B-b). However, unlike the derivative of acrylic acid, the side reaction of a Reaction Equation (B-c) does not occur in case of the derivative of methacrylic acid.

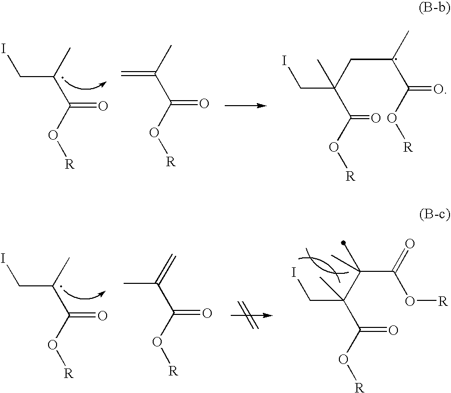

In case of the Reaction Equation (B-c), stearic hindrance occurs due to a methyl group that is located at the center of the radical reaction. Thus, it is difficult to form a reaction side product described above.

As such, when methacrylic acid and the derivative thereof are contained, it is possible to significantly reduce the amount of low molecular weight resin or uncured resin due to the unstable reaction of acrylic acid and the derivative thereof. Further, when the sealant containing methacrylic acid and the derivative thereof is applied to the liquid crystal display, it is possible to prevent impurities from being formed in the liquid crystal layer due to low molecular weight resin or uncured resin.

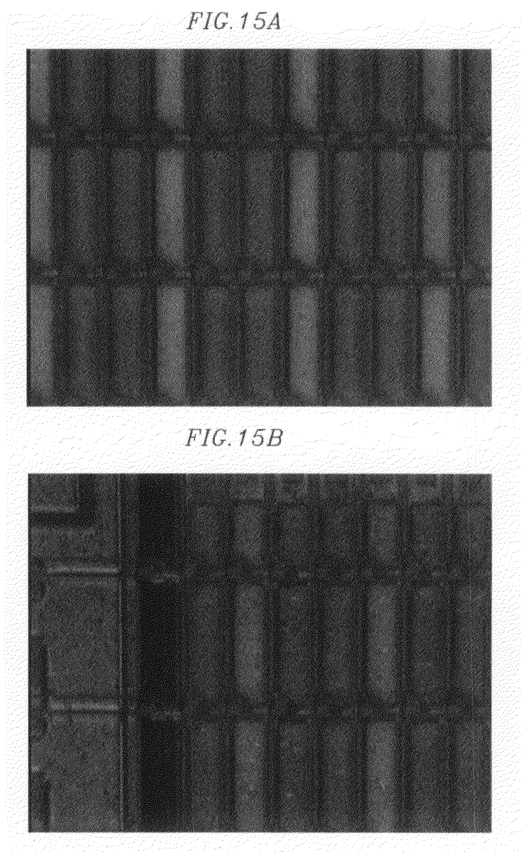

FIGS. 15A and 15B are photographs showing the generation of stains on the liquid crystal display when the sealant containing the derivative of methacrylic acid and the sealant containing the derivative of acrylic acid are used, respectively.

From FIGS. 15A and 15B, it can be seen that it is possible to significantly reduce the stains due to the impurities when the sealant containing the derivative of methacrylic acid is used, compared with when the sealant containing the derivative of acrylic acid is used. In addition, the residual image characteristics can be compared.

The residual image characteristic may be tested by the following method.

First, liquid crystal display panels for testing the sealant containing the derivative of methacrylic acid and the sealant containing the derivative of acrylic acid, respectively, are prepared. A plurality of pixels is disposed in the display panels in a check pattern. A gray data voltage, not white or black, is applied to the display panel so as to measure the luminance of the screen, while some of the plurality of pixels alternately disposed in vertical and horizontal directions are displayed black, and others are displayed white. Then, the display panels are left for about 10 hours. Subsequently, the gray data voltage that is initially applied is applied again so as to measure luminance of the screen and to check the degree of residual image.

As a result, no residual image was observed on the liquid crystal display panel that used the sealant containing the derivative of methacrylic acid. However, the residual image was clearly observed on the liquid crystal display panel that used the sealant containing the derivative of acrylic acid.

The sealant according to the exemplary embodiment of the present invention may further contain an epoxy compound and a small amount of the derivative of acrylic acid as a monomer, in addition to methacrylic acid and the derivative thereof.

The epoxy compound may increase adhesion strength of the sealant, and may have a content of about 0.1 to 20% by weight with respect to the total content of the monomer.

The sealant may selectively contain acrylic acid and the derivative thereof in order to increase the curing rate of the sealant.

The monomer may have a content of about 45 to 75% by weight, and preferably about 50 to 60% by weight, with respect to the total content of the sealant.

The photoinitiator is a component that absorbs energy during irradiation of UV so as to initiate a polymerization reaction, and may include, for example, a benzophenone compound or the like.

The photoinitiator may have a content of about 0.1 to 5% by weight with respect to the total content of the sealant.

The filler is a component that reinforces the thermal and physical properties of the sealant after curing, and may include an inorganic material, such as silicon oxide (SiO₂), or an organic material.

The filler may comprise about 5 to 40% by weight of the total weight of the sealant.

A curing agent may be an amine compound, and may have a content of about 0.1 to 20% by weight with respect to the total content of the sealant.

The sealant may further contain various types of additives in addition to the above-mentioned components.

Hereinafter, a liquid crystal display to which the sealant according to the exemplary embodiment of the present invention is applied will be described in detail with reference to the accompanying drawings such that the present invention can be easily accomplished by those skilled in the art. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present.

Hereinafter, the liquid crystal display according to the exemplary embodiment of the present invention will be described.

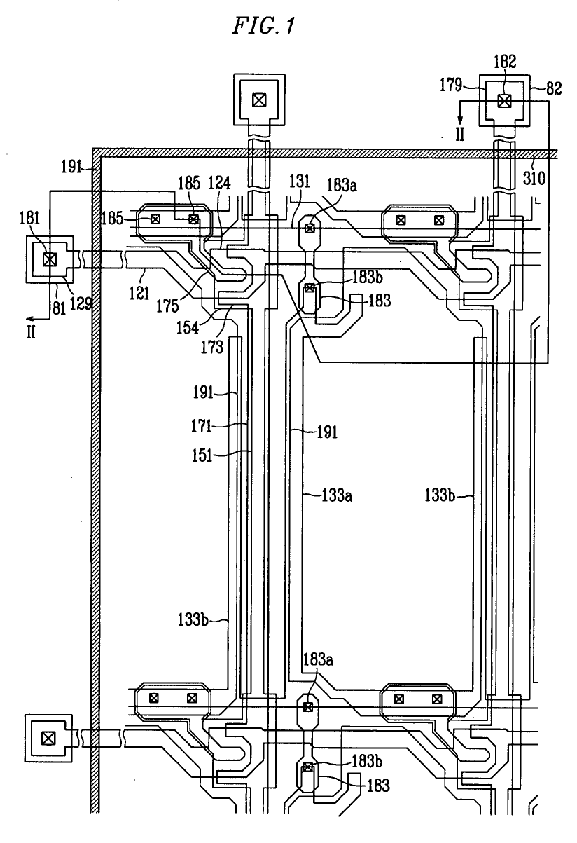

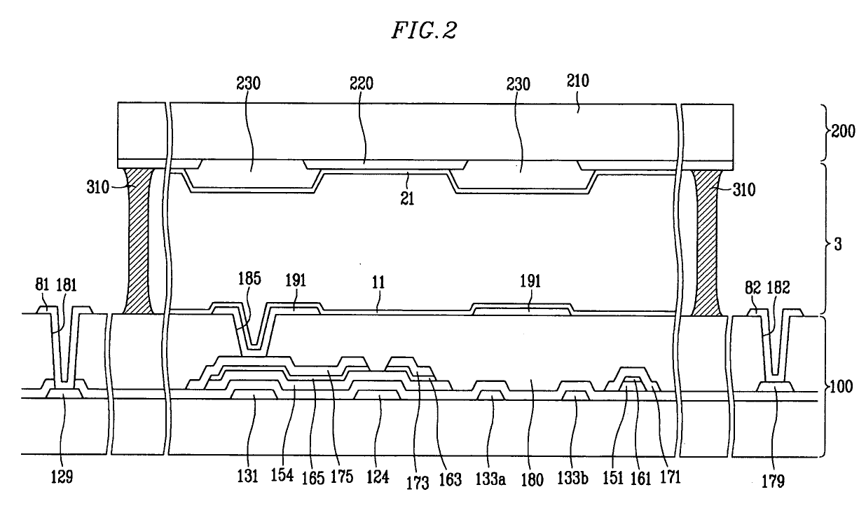

FIG. 1 is a layout view of the liquid crystal display according to the exemplary embodiment of the present invention, and FIG. 2 is a cross-sectional view of the liquid crystal display of FIG. 1 taken along the line II-II.

Referring to FIGS. 1 and 2, the liquid crystal display according to the exemplary embodiment of the present invention includes a thin film transistor display panel 100 and a common electrode display panel 200 that face each other, and a liquid crystal layer 3 that is interposed between the two display panels 100 and 200.

First, the thin film transistor display panel 100 will be described.

A plurality of gate lines 121 and a plurality of storage electrode lines 131 are formed on an insulating substrate 110 made of, for example, transparent glass, or plastic.

The gate lines 121 transmit gate signals and substantially extend in a horizontal direction. Each of the gate lines 121 includes a plurality of gate electrodes 124 protruding downward and a wider end portion 129 to be connected to another layer or an external driving circuit.

A predetermined voltage is applied to the storage electrode lines 131. Each of the storage electrode lines 131 includes a stem line substantially extending in parallel with the gate line 121 and a plurality of pairs of first and second storage electrodes 133a and 133b branched from the stem line. Each of the storage electrode lines 131 is provided between two adjacent gate lines 121.The stem line is closer to the lower one of the two adjacent gate lines 121. Each of the storage electrodes 133a and 133b includes a fixed end connected to the stem line, and a free end that is provided on the opposite side. The fixed end of the first storage electrode 133a has a large area, and the free end is divided into a straight portion and a bent portion. However, the shape and arrangement of the storage electrode line 131 may be modified in various ways.

The gate lines 121 and the storage electrode lines 131 may be made of an aluminum-containing metal such as aluminum (Al) or an aluminum alloy, a silver-containing metal such as silver (Ag) or a silver alloy, a copper-containing metal such as copper (Cu) or a copper alloy, a molybdenum-containing metal such as molybdenum (Mo) or a molybdenum alloy, chromium (Cr), tantalum (Ta), or titanium (Ti). However, the gate lines and the storage electrode lines may have a multilayer structure including two conductive layers (not shown) having different physical properties.

The side surfaces of the gate lines 121 and the storage electrode lines 131 may be inclined with respect to a surface of the substrate 110, and the inclination angle may be in a range of about 30 to 800.

A gate insulating layer 140 made of, for example, silicon nitride (SiNₓ) or silicon oxide (SiO₂), is formed on the gate lines 121 and the storage electrode lines 131. A plurality of semiconductor stripes 151 made of hydrogenated amorphous silicon (simply referred to as “a-Si”) or polysilicon are formed on the gate insulating layer 140. The semiconductor stripes 151 substantially extend in a vertical direction, and include a plurality of projections 154 protruding toward the gate electrodes 124.

A plurality of ohmic contact stripes and islands 161 and 165 are formed on the semiconductor stripes 151. The ohmic contacts 161 and 165 may be made of n+hydrogenated amorphous silicon in which an n-type impurity such as phosphorus (P) is doped with a high concentration, or silicide. The ohmic contact stripes 161 include a plurality of protrusions 163, and the protrusions 163 and the ohmic contact islands 165 are provided in pairs on the projections 154 of the semiconductor stripes 151.

The side surfaces of the semiconductor stripes 151 and the ohmic contacts 161 and 165 may be inclined with respect to the surface of the substrate 110, and the inclination angle is in a range of about 30 to 800.

A plurality of data lines 171 and a plurality of drain electrodes 175 are formed on the ohmic contacts 161 and 165 and the gate insulating layer 140.

The data lines 171 transmit data signals, and substantially extend in a vertical direction so as to cross the gate lines 121. Further, each of the data lines 171 crosses the storage electrode line 131 to extend between adjacent storage electrodes 133a and 133b. Each of the data lines 171 includes a plurality of source electrodes 173 extending toward the gate electrodes 124 and a wider end portion 179 so as to be connected to another layer or an external driving circuit.

The drain electrodes 175 are separated from the data lines 171, and face the source electrodes 173 on the gate electrodes 124.

One gate electrode 124, one source electrode 173, one drain electrode 175, and the projection 154 of the semiconductor stripe 151 form one thin film transistor (TFT), and a channel of the thin film transistor is provided in the projection 154 between the source electrode 173 and the drain electrode 175.

The data lines 171 and the drain electrodes 175 may be made of the same metal as the gate lines 121 and the storage electrode lines 131.

The side surfaces of the data lines 171 and the drain electrodes 175 may be inclined with respect to the surface of the substrate 110, and the inclination angle may be in a range of about 30 to 800.

A passivation layer 180 is formed on the data lines 171, the drain electrodes 175, and exposed portions of the semiconductor stripes 151. The passivation layer 180 may be made of an inorganic insulator or an organic insulator, and has a flat surface.

A plurality of contact holes 182 and 185 are formed in the passivation layer 180 to expose the end portions 179 of the data lines 171 and the drain electrodes 175, respectively. Further, in the passivation layer 180 and the gate insulating layer 140, a plurality of contact holes 181 are formed to expose the end portions 129 of the gate lines 121, a plurality of contact holes 183a are formed to expose portions of the storage electrode lines 131 in the vicinity of the fixed ends of the first storage electrodes 133a, and a plurality of contact holes 183b are formed to expose the projections of the free ends of the first storage electrodes 133a.

A plurality of pixel electrodes 191, a plurality of overpasses 83, and a plurality of contact assistants 81 and 82 are formed on the passivation layer 180. They may be formed of a transparent conductive material such as indium tin oxide (ITO) or indium zinc oxide (IZO), or a reflective metal such as Al, Ag, Cr, or an alloy thereof.

The pixel electrodes 191 are physically and electrically connected to the drain electrodes 175 through the contact holes 185, and a data voltage is applied to the pixel electrodes 191 from the drain electrodes 175.

The pixel electrodes 191 to which the data voltage is applied and the common electrode 270 of another display panel 200 to which a common voltage is applied generate an electric field so as to determine the alignment of liquid crystal molecules in the liquid crystal layer 3 between the two electrodes 191 and 270. The polarization of light passing through the liquid crystal layer 3 depends on the alignment of the liquid crystal molecules determined in such a manner. The pixel electrode 191 and the common electrode 270 form a capacitor (hereinafter referred to as a “liquid crystal capacitor”) to maintain the applied voltage even after the thin film transistor is turned off.

The pixel electrode 191 overlaps the storage electrodes 133a and 133b and the storage electrode line 131. The pixel electrode 191 and the drain electrode 175 electrically connected to the pixel electrode 191 overlap the storage electrode line 131 so as to form a capacitor that is called a storage capacitor. The storage capacitor reinforces a voltage maintaining capability of the liquid crystal capacitor.

The contact assistants 81 and 82 are connected to the end portion 129 of the gate line 121 and the end portion 179 of the data line 171 through the contact holes 181 and 182. The contact assistants 81 and 82 complement adhesion strength between the end portion 129 of the gate line 121 and the end portion 179 of the data line 171, and an external device, and protect them.

The overpass 83 crosses the gate line 121, and is connected to the exposed portion of the storage electrode line 131 and to the exposed end portion of the free end of the storage electrode 133b through the contact holes 183a and 183b with the gate line 121 interposed therebetween.

Next, a common electrode display panel 200 that faces the thin film transistor display panel 100 will be described.

A light blocking member 220 that is called a black matrix is formed on an insulating substrate 210 made of, for example, transparent glass, or plastic. The light blocking member 220 has a plurality of openings facing the pixel electrodes 191 and having almost the same shape as the pixel electrodes 191, and prevents light from leaking between the pixel electrodes 191. The light blocking member 220 may include a portion corresponding to the gate line 121 and the data line 171, and a portion corresponding to the thin film transistor.

A plurality of color filters 230 are formed on the substrate 210. Most of the color filters 230 are disposed in regions surrounded by the light blocking member 220, and may extend in a predetermined direction. Each of the color filters 230 can display one of three primary colors of red, green, and blue.

The common electrode 270 that is made of ITO or IZO is formed on the color filters 230.

Alignment layers 11 and 21 that are made of an insulating material such as polyimide or the like are coated on internal surfaces of the display panels 100 and 200, and may be horizontal alignment layers.

Polarizers (not shown) are provided on external surfaces of the display panels 100 and 200, and polarization axes of the two polarizers may be parallel or perpendicular to each other. In a reflective liquid crystal display, one of the two polarizers may be omitted.

The two display panels 100 and 200 are assembled to each other using a sealant 310, and the liquid crystal layer 3 including a plurality of liquid crystal molecules is formed in a region defined by the sealant 310.

The sealant 310 contains a polymer resin formed by curing methacrylic acid and the derivative thereof, the epoxy compound, and acrylic acid and the derivative thereof, a photoinitiator, a filler, a curing agent, and various additives.

The liquid crystal layer 3 may have positive dielectric anisotropy, and the liquid crystal molecules in the liquid crystal layer 3 are aligned such that major axes of the liquid crystal molecules are substantially parallel to the surfaces of the two display panels 100 and 200 when an electric field is not applied.

Next, a method of manufacturing the liquid crystal display shown in FIGS. 1 and 2 will be described.

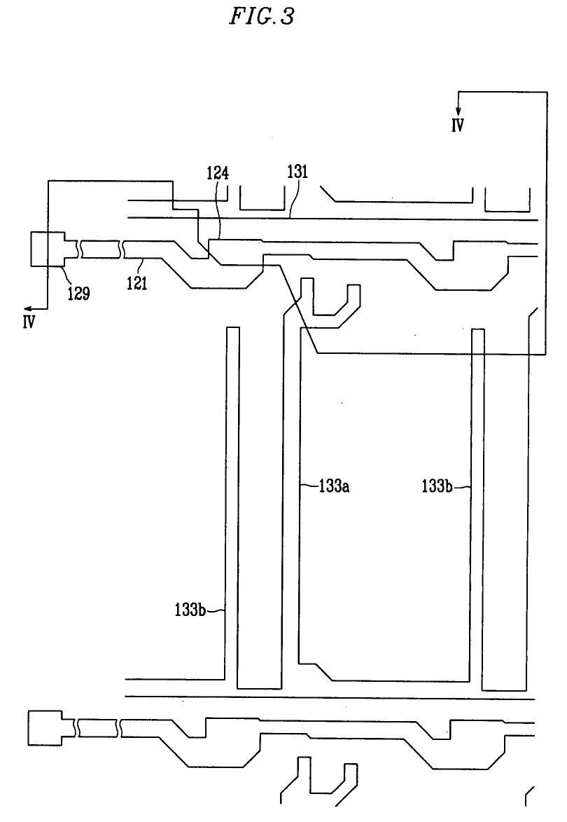

First, a method of manufacturing the thin film transistor display panel 100 will be described in detail with reference to FIGS. 3 to 12.

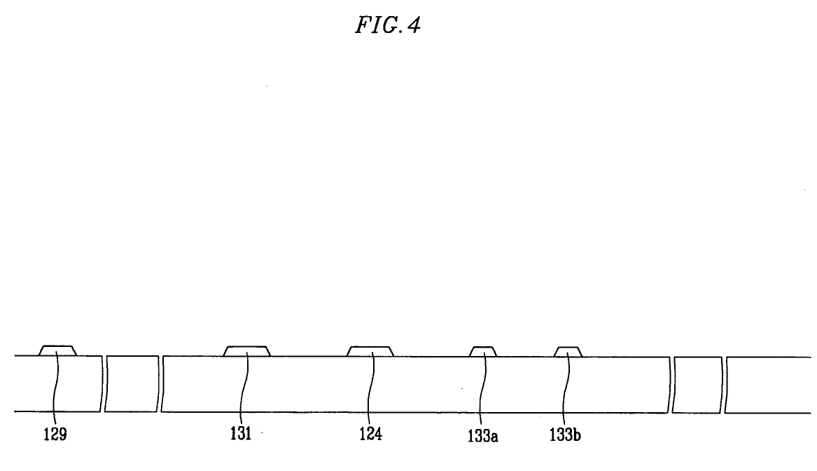

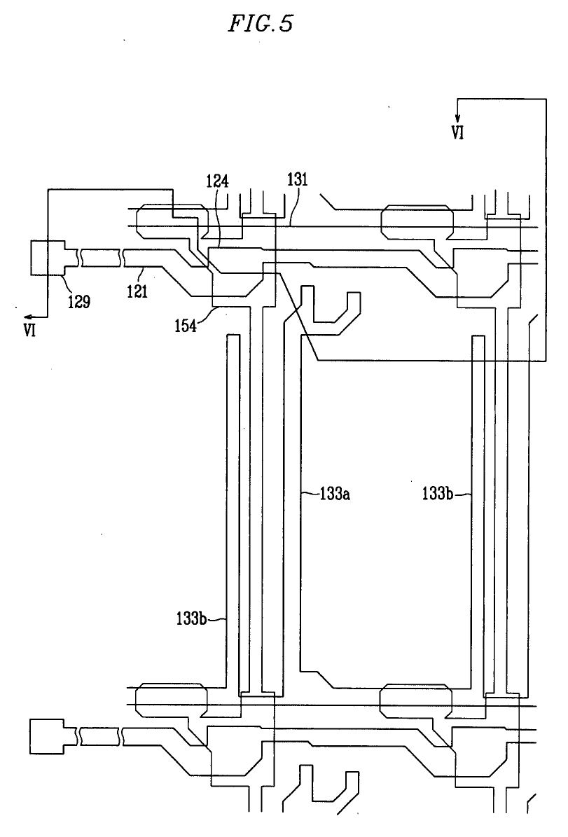

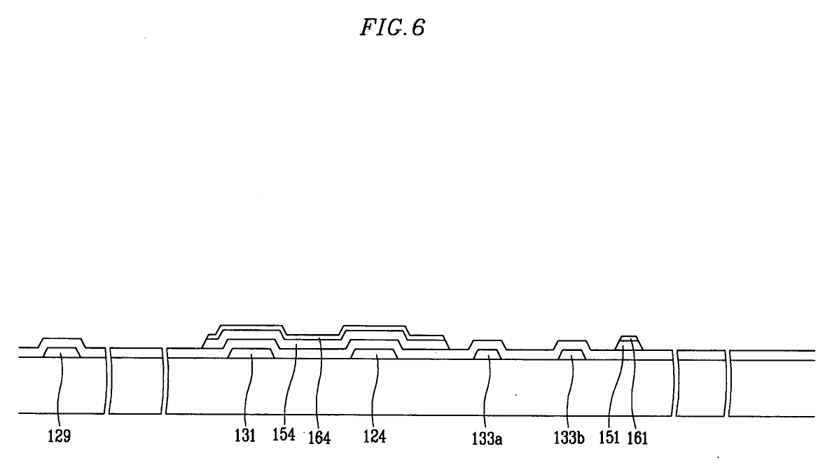

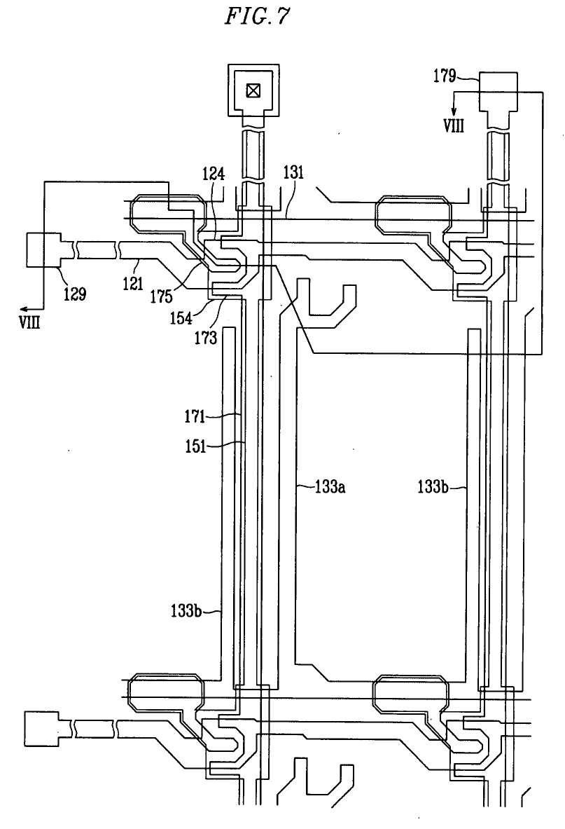

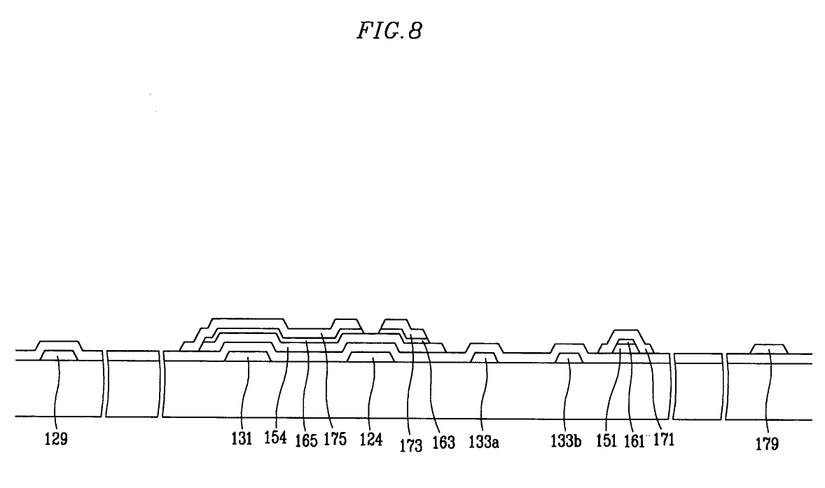

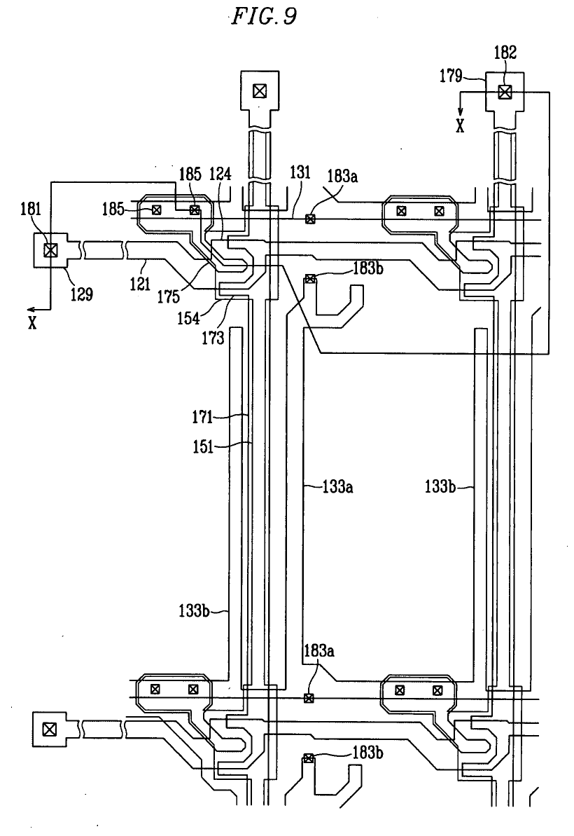

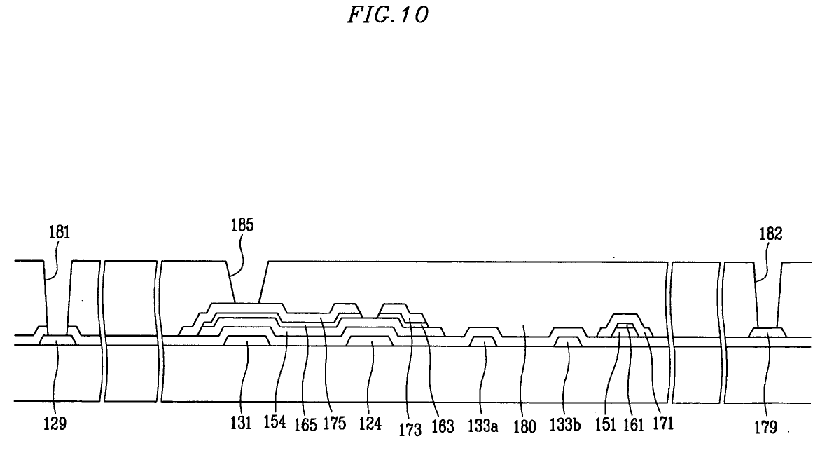

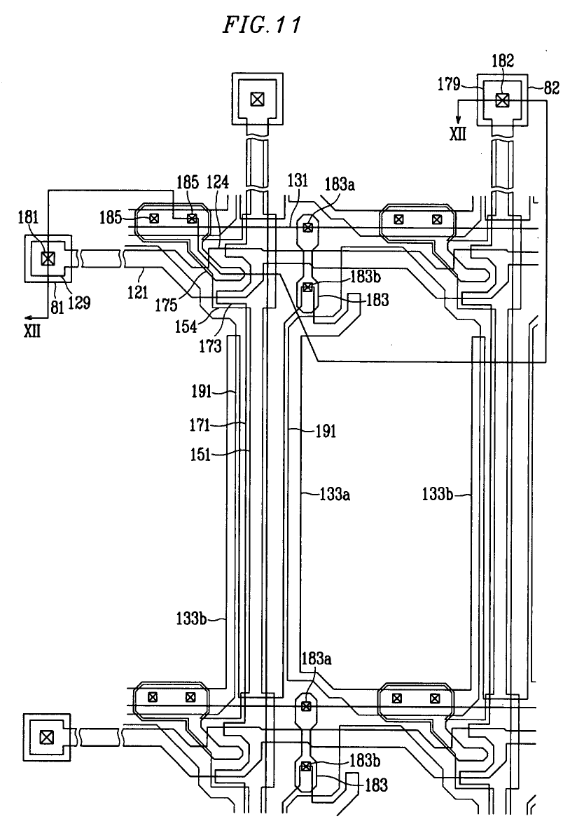

FIGS. 3, 5, 7, 9, and 11 are layout views sequentially showing a method of manufacturing a thin film transistor display panel according to an exemplary embodiment of the present invention. FIG. 4 is a cross-sectional view of the thin film transistor display panel of FIG. 3 taken along the line IV-IV. FIG. 6 is a cross-sectional view of the thin film transistor display panel of FIG. 5 taken along the line VI-VI. FIG. 8 is a cross-sectional view of the thin film transistor display panel of FIG. 7 taken along the line VIII-VIII. FIG. 10 is a cross-sectional view of the thin film transistor display panel of FIG. 9 taken along the line X-X. FIG. 12 is a cross-sectional view of the thin film transistor display panel of FIG. 11 taken along the line XII-XII.

First, a metal layer, such as Al or the like, is formed on the insulating substrate 110.

As shown in FIGS. 3 and 4, the metal layer is wet-etched to form a plurality of gate lines 121 including the gate electrodes 124 and the end portions 129 and a plurality of storage electrode lines 131 including the storage electrodes 133a and 133b.

Subsequently, the gate insulating layer 140 made of SiNₓ, a-Si layer, and n+ a-Si layer are formed on the gate lines 121 and the storage electrode lines 131 using plasma enhanced chemical vapor deposition (PECVD).

Next, as shown in FIGS. 5 and 6, the n+ a-Si layer and a-Si layer are subjected to a photolithography and etching process to form the gate insulating layer 140, an semiconductor strip 151 including a plurality of projections 154, and an ohmic contact 161 that includes a plurality of impurity semiconductor patterns 164.

Next, as shown in FIGS. 7 and 8, the metal layer, such as Al or the like, is formed on the ohmic contact 161, using sputtering, and then etched to form the data lines 171 including the source electrodes 173 and the end portions 179, and the drain electrodes 175.

Next, the impurity semiconductor layer 164 that is not covered with the source electrodes 173 and the drain electrodes 175 but is exposed is removed to form a plurality of ohmic contact strips 161 including a plurality of protrusions 163 and a plurality of ohmic contact islands 165 and to expose portions of the projection 154 of the semiconductor stripes 151. In this case, an oxygen (O₂) plasma treatment is performed to stabilize the surfaces of the projections 154 of the semiconductor stripes 151.

Next, as shown in FIGS. 9 and 10, the passivation layer 180 that is made of an organic material or an inorganic material having an excellent planarization characteristic and photosensitivity is formed.

Next, a photosensitive layer is formed on the passivation layer 180, then light is irradiated using a photomask and subsequently development is performed, to thereby form a plurality of contact holes 181, 182, 183a, 183b, and 185.

Next, as shown in FIGS. 11 and 12, a transparent conductive layer made of ITO or IZO is deposited on the passivation layer 180 using sputtering, and then patterned to form the pixel electrodes 191, the contact assistants 81 and 82, and the overpasses 83.

Next, a method of manufacturing the common electrode display panel 200 that faces the thin film transistor display panel 100 will be briefly described.

First, the light blocking member 220 made of a non-transparent metal is formed on the insulating substrate 210.

Subsequently, the color filters 230 are formed. The color filters 230 are made of photosensitive organic materials including red, green, and blue pigments by spin coating or inkjet printing, and then exposure and development are performed to form predetermined patterns.

Next, the transparent conductive layer made of ITO or IZO is formed on the entire surfaces of the color filters 230 and the light blocking member 220 using sputtering to form the common electrode 270.

Through the above-mentioned method, the thin film transistor display panel 100 and the common electrode display panel 200 are prepared.

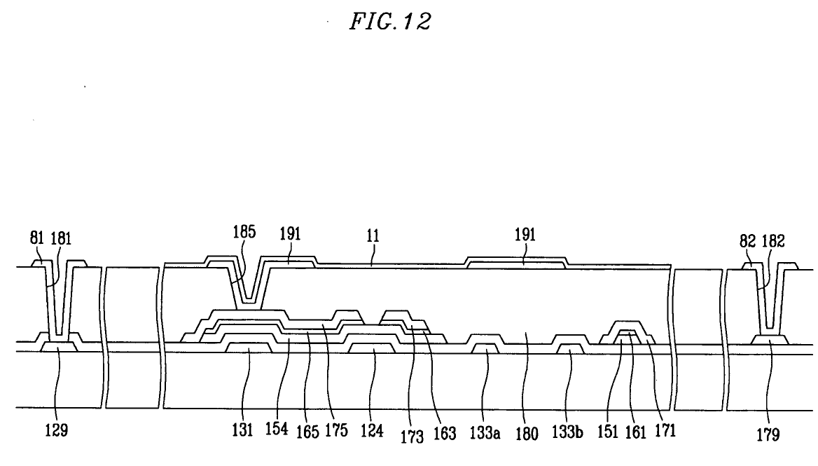

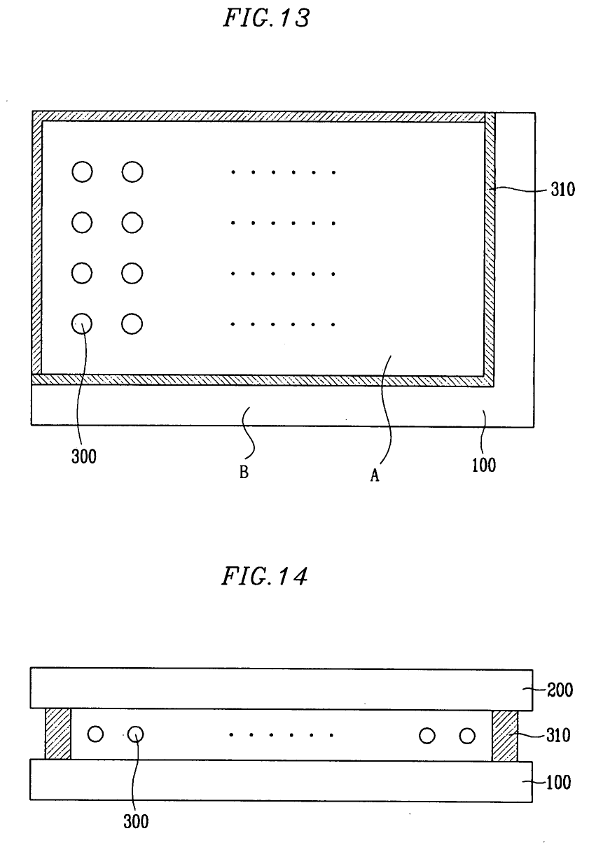

Next, the sealant 310 and the formation of liquid crystal will be described with reference to FIGS. 13 and 14.

FIG. 13 is a plan view showing a case where the sealant and liquid crystal are formed on the thin film transistor display panels of FIGS. 11 and 12. FIG. 14 is a cross-sectional view of a structure when the thin film transistor display panel and the common electrode display panel are bonded to each other.

As shown in FIG. 13, the sealant 310 is formed at the boundary of the display region (A) on the thin film transistor display panel 100 and the pad region (B) for connection of the driving circuits.

The sealant 310 contains the above-mentioned polymer resin.

Next, liquid crystal droplets 300 are dropped in the display region (A) that is defined by the sealant 310. For the application of the liquid crystal droplets 300, it is preferable that one droplet of liquid crystal is about 1 to 15 mg.

As shown in FIG. 14, the thin film transistor display panel 100 on which liquid crystal 300 is provided is assembled to the common electrode display panel 200. UV is irradiated onto the sealant 310 to cure the sealant 310. The photoinitiator that is contained in the sealant 310 reacts with UV upon curing. Thus, the monomer containing methacrylic acid and the derivative thereof is cured.

A process of thermosetting the sealant 310 may be further performed. During thermosetting, heating is performed at about 120° C. for about 60 minutes to cure remaining epoxy resin.

In the above-mentioned embodiment, only a case where liquid crystal 300 is dropped on the thin film transistor display panel 100 has been described. However, liquid crystal 300 may be dropped on the common electrode display panel 200. Further, in the above-mentioned embodiment, only a case where the sealant 310 is formed on the thin film transistor display panel 100 has been described. However, the sealant may be formed on the common electrode display panel 200. In addition, the sealant 310 and liquid crystal 300 may be provided on different display panels 100 and 200.

The sealant containing methacrylic acid and the derivative thereof significantly reduces the amount of low molecular weight resin or uncured resin to prevent an impurity from being diffused into the liquid crystal layer, thereby improving display characteristics without stains or residual images.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A sealant comprising:
methacrylic acid or a derivative thereof;
a photoinitiator; and
a filler.

2. The sealant of claim 1, wherein the derivative of methacrylic acid is expressed by Formula I: 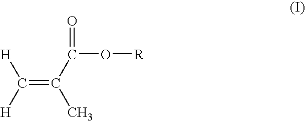
in which R is any one selected from the group consisting of an amide group, an ester group, an ether group, a sulfide group, a sulfoxide group., a hydroxy group, an imide group, an aza group, an amine group, an azo group, an aldehyde group, a carboxylic group, anhydrides, halides, and ureas.

3. The sealant of claim 1, further comprising at least one of acrylic acid or a derivative thereof and an epoxy compound.

4. The sealant of claim 3, wherein methacrylic acid or the derivative thereof, acrylic acid or the derivative thereof, and the epoxy compound have a content of about 45 to 75% by weight with respect to a total content of the sealant.

5. The sealant of claim 4, wherein methacrylic acid or the derivative thereof has a content of about 0.1 to 98% by weight with respect to the total content of methacrylic acid or the derivative thereof, acrylic acid or the derivative thereof, and the epoxy compound.

6. A liquid crystal display comprising:
a first display panel and a second display panel that face each other;
a sealant that comprises polymer resin formed by curing methacrylic acid or a derivative thereof to assemble the first display panel and the second display panel; and
a liquid crystal that is provided in a region defined by the sealant between the first display panel and the second display panel.

7. The liquid crystal display of claim 6, wherein the derivative of methacrylic acid is expressed by Formula I: 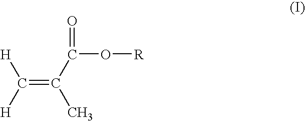
in which R is any one selected from the group consisting of an amide group, an ester group, an ether group, a sulfide group, a sulfoxide group, a hydroxy group, an imide group, an aza group, an amine group, an azo group, an aldehyde group, a carboxylic group, anhydrides, halides, and ureas.

8. The liquid crystal display of claim 6, wherein the sealant further comprises polymer resin formed by curing at least one of acrylic acid or a derivative thereof and an epoxy compound.

9. The liquid crystal display of claim 8, wherein the sealant further comprises at least one of a photoinitiator, a filler, and an additive.

10. The liquid crystal display of claim 6, wherein at least one of the first display panel and the second display panel comprises field generating electrodes.

11. The liquid crystal display of claim 10, wherein the first display panel or the second display panel comprises:
gate lines;
data lines that cross the gate lines; and
thin film transistors that are connected to the gate lines, the data lines, and the field generating electrodes.

12. A method of manufacturing a liquid crystal display, comprising:
forming a first display panel and a second display panel having a plurality of thin film patterns;
forming a sealant that comprises methacrylic acid and a derivative thereof on any one of the first display panel and the second display panel;
providing a liquid crystal on any one of the first display panel and the second display panel;
assembling the first display panel and the second display panel; and curing the sealant.

13. The method of claim 12, wherein the curing of the sealant is performed using at least one of light irradiation and heating.

14. The method of claim 12, wherein the forming of the first display panel comprises:
forming gate lines on a first substrate;
forming a semiconductor layer on the gate lines;
forming data lines and drain electrodes that cross the gate lines so as to be insulated from the gate lines; and
forming pixel electrodes that are correspondingly connected to the drain electrodes.
